(19) United States
(12) Patent Application Publication
(10) Pub. No.: US 2020/0301024 A1
(43) Pub. Date: Sep. 24, 2020

(54) CIRCUIT FOR A RECEIVER RF FRONT END AND A METHOD OF SAME

(71) Applicant: Beken Corporation, Shanghai (CN)

(72) Inventors: Yiming Huang, Shanghai (CN); Weifeng Wang, Shanghai (CN)

(73) Assignee: Beken Corporation, Shanghai (CN)

(21) Appl. No.: 16/377,844

(22) Filed: Apr. 8, 2019

(30) Foreign Application Priority Data
Mar. 20, 2019 (CN) 201910214786.X

(51) Int. Cl. G01S 19/33; G01S 19/36

(52) U.S. Cl. CPC G01S 19/33; G01S 19/36

(57) ABSTRACT

An RF front end circuit in a receiver, comprising a low noise amplifier configured to receive an RF signal from an antenna; a frequency synthesizer and divider, configured to generate a first local oscillation signal and a second local oscillation signal; a first mixer configured to generate a first middle frequency signal by mixing the RF signal with the first local oscillation signal; a second mixer configured to generate a second middle frequency signal by mixing the first middle frequency signal with the second local oscillation signal; a first complex band path filter configured to generate a first satellite navigation signal by filtering the first middle frequency signal; a second complex band path filter configured to generate a second satellite navigation signal by filtering the second middle frequency signal, wherein the second satellite navigation signal is different from the first satellite navigation signal.

### CROSS REFERENCE TO RELATED APPLICATIONS

This application claims priority to Chinese Application number 201910214786.X entitled “CIRCUIT FOR A RECEIVER RF FRONT END AND A METHOD OF SAME,” filed on Mar. 20, 2019 by Beken Corporation, which is incorporated herein by reference.

### TECHNICAL FIELD

The present application relates to a receiver's RF front end, but not exclusively, to a circuit for a receiver's RF front end and a method of the same.

### BACKGROUND

Global Navigation Satellite Systems (GNSS) can provide users with accurate location, speed, and time signals, which has developed rapidly in recent years. GNSS mainly includes the United States' Global Positioning System (GPS), China's Beidou System (BDS), Russia's GLONASS system and the EU's Galileo System (Galileo).

Due to the effect of spatial obstruction, a single GPS satellite receiver often cannot receive signals from enough satellites with good geometry, resulting in longer positioning times and poor positioning accuracy. Therefore, it may be helpful to receive GLONASS or BDS at the same time to speed up the positioning time to improve the positioning accuracy. This system is called a dual-mode satellite receiver that receives GPS+BDS or GPS+GLONASS simultaneously.

A RF front-end circuit is a key module in the dual-mode satellite receiver, which has a significant impact on the performance, power consumption, and cost of the entire receiver. The RF front-end circuit of a conventional dual-mode satellite receiver is generally composed of two independent RF receive paths, which has twice cost and power consumption of the single-mode receiver. In addition, the two frequency synthesizers within each RF path operate at different RF frequencies and are prone to mutual interference.

### SUMMARY

According to an aspect of an embodiment of the invention, an RF front end circuit in a receiver, comprising a low noise amplifier configured to receive an RF signal from an antenna; a frequency synthesizer and divider, configured to generate a first local oscillation signal and a second local oscillation signal; a first mixer communicatively connected to the low noise amplifier and the frequency synthesizer and divider, and configured to generate a first middle frequency signal by mixing the RF signal with the first local oscillation signal; a second mixer communicatively connected to the first mixer and the frequency synthesizer and divider, and configured to generate a second middle frequency signal by mixing the first middle frequency signal with the second local oscillation signal; a first complex band path filter communicatively connected to the first mixer and configured to generate a first satellite navigation signal by filtering the first middle frequency signal to suppress signal in unwanted frequency band; a second complex band path filter communicatively connected to the second mixer and configured to generate a second satellite navigation signal by filtering the second middle frequency signal to suppress signal in unwanted frequency band, wherein the second satellite navigation signal is different from the first satellite navigation signal; a first analog to digital converter (ADC) communicatively coupled to the first complex band path filter and configured to generate a first digital satellite navigation signal by converting the first satellite navigation signal digitally; and a second analog to digital converter (ADC) communicatively coupled to the second complex band path filter and configured to generate a second digital satellite navigation signal by converting the second satellite navigation signal digitally.

According to another aspect of the embodiments of the invention, a method in a receiver, comprising receiving, by a low noise amplifier (LNA), an RF signal from an antenna; generating, by a frequency synthesizer and divider, a first local oscillation signal and a second local oscillation signal; generating, by a first mixer communicatively connected to the low noise amplifier and the frequency synthesizer and divider, a first middle frequency signal by mixing the RF signal with the first local oscillation signal; generating, by a second mixer communicatively connected to the first mixer and the frequency synthesizer and divider, a second middle frequency signal by mixing the first middle frequency signal with the second local oscillation signal; generating, by a first complex band path filter communicatively connected to the first mixer, a first satellite navigation signal by filtering the first middle frequency signal to suppress signal in unwanted frequency band; generating, by a second complex band path filter communicatively connected to the second mixer, a second satellite navigation signal by filtering the second middle frequency signal to suppress signal in unwanted frequency band, wherein the second satellite navigation signal is different from the first satellite navigation signal; generating, by a first analog to digital converter communicatively coupled to the first complex band path filter, a first digital satellite navigation signal by converting the first satellite navigation signal digitally; and generating, by a second analog to digital converter communicatively coupled to the second complex band path filter, a second digital satellite navigation signal by converting the second satellite navigation signal digitally.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a circuit diagram of a RF front end in a receiver according to an embodiment of the invention.

FIG. 2 is a circuit diagram of a RF front end in a receiver according to another embodiment of the invention.

FIG. 3 is a circuit diagram of a complex band path filter within the RF front end in a receiver according to an embodiment of the invention.

FIG. 4 is a flow chart of a method in a RF front end in a receiver according to an embodiment of the invention.

### DETAILED DESCRIPTION OF THE ILLUSTRATED EMBODIMENTS

Various aspects and examples of the invention will now be described. The following description provides specific details for a thorough understanding and enabling description of these examples. Those skilled in the art will understand, however, that the invention may be practiced without many of these details.

Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below, however, any terminology intended to be interpreted in any restricted manner will be overtly and specifically defined as such in this Detailed Description section.

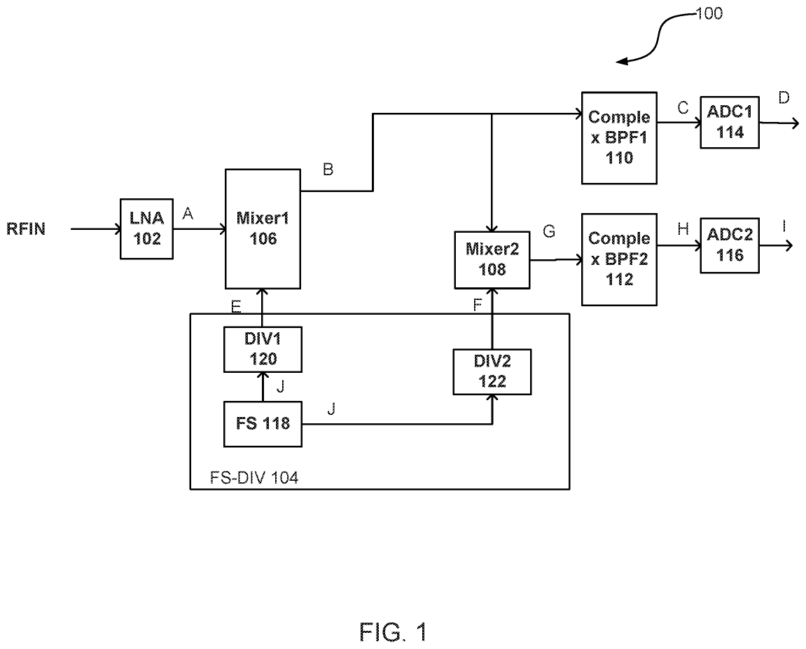

FIG. 1 is a circuit diagram of a RF front end circuit 100 in a receiver according to an embodiment of the invention.

The RF front end circuit 100 comprises a low noise amplifier (LNA) 102, a frequency synthesizer and divider FS-DIV 104, a first mixer 106, a second mixer 108, a first complex band pass filter (BPF) 110, a second complex band pass filter (BPF) 112, a first analog to digital converter (ADC1) 114 and a second analog to digital converter (ADC2) 116. The LNA 102 is configured to generate an amplified RF signal A from an RF signal received from an antenna. The frequency range of the RF signals are shown as followed: 1575.42 MHz for GPS signal, 1598.0625-1609.3125 MHz for GLONASS signal and 1561.098 MHz for BDS signal. The frequency synthesizer and divider 104 is configured to generate a first local oscillation signal E and a second local oscillation signal F. The first mixer 106 is communicatively connected to the LNA 102 and the frequency synthesizer and divider FS-DIV 104, and is configured to generate a first middle frequency signal B by mixing the amplified RF signal A with the first local oscillation signal E. The second mixer 108 is communicatively connected to the first mixer 106 and the frequency synthesizer and divider FS-DIV 104, and configured to generate a second middle frequency signal G by mixing the first middle frequency signal B with the second local oscillation signal F. The first complex band path filter 110 is communicatively connected to the first mixer 106 and configured to generate a first satellite navigation signal C by filtering the first middle frequency signal B to suppress signal in unwanted frequency band. The second complex band path filter 112 is communicatively connected to the second mixer 108 and configured to generate a second satellite navigation signal H by filtering the second middle frequency signal G to suppress signal in unwanted frequency band. The second satellite navigation signal H is different from the first satellite navigation signal C. The first band path filter may have a pass frequency of 2.2 MHz, and the second band path filter may have a pass frequency of 11.3 MHz for GLONASS mode, or a pass frequency of 4.2 MHz for BDS mode.

The first analog to digital converter (ADC1) 114 is communicatively coupled to the first complex band path filter 110 and configured to generate a first digital satellite navigation signal D by converting the first satellite navigation signal C digitally. The second analog to digital converter (ADC2) 116 is communicatively coupled to the second complex band path filter 112 and configured to generate a second digital satellite navigation signal I by converting the second satellite navigation signal H digitally.

As further shown in FIG. 1, alternatively, the frequency synthesizer and divider 104 further comprises a frequency synthesizer FS 118, a first divider 120 and a second divider 122. The frequency synthesizer 118 is communicatively coupled to both the first divider 120 and the second divider 122, and configured to generate and send a double-frequency signal J to both the first divider 120 and the second divider 122. The first divider 120 is further communicatively coupled to the first mixer 106 and configured to send the first local oscillation frequency signal E to the first mixer 106 by dividing the double-frequency signal J by two. The second divider 122 is further communicatively coupled to the second mixer 108 and configured to send the second local oscillation frequency signal F to the second mixer by dividing the double-frequency signal J by a divisor.

### Embodiment 1

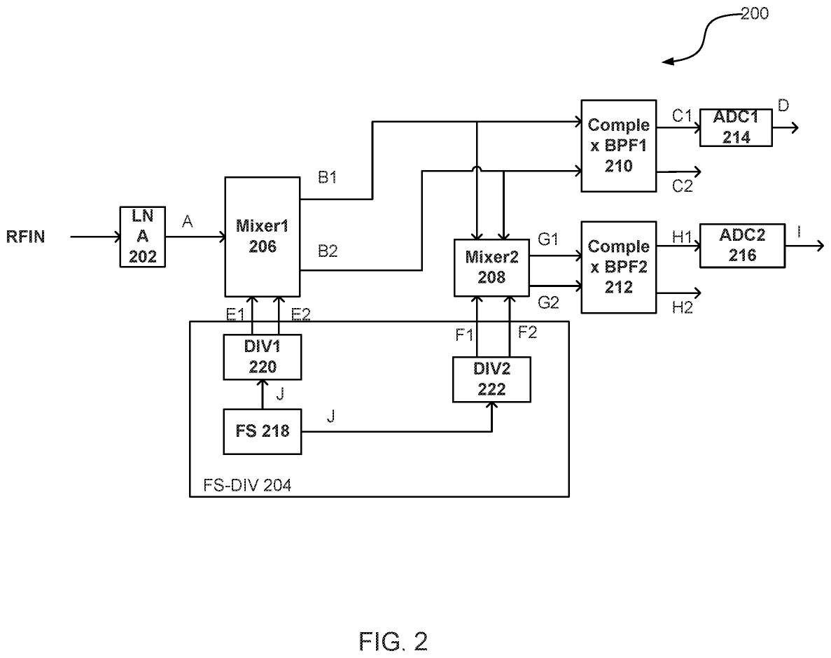

FIG. 2 is a circuit diagram of a RF front end 200 in a receiver according to another embodiment of the invention. The RF front end 200 includes similar circuit components as the RF front end 100 shown in FIG. 1. The RF front end circuit 200 comprises a low noise amplifier 202, a frequency synthesizer and divider FS-DIV 204, a first mixer 206, a second mixer 208, a first complex band pass filter (BPF) 210, a second complex band pass filter (BPF) 212, a first analog to digital converter (ADC) 214 and a second analog to digital converter (ADC) 216.

The frequency synthesizer and divider 204 is configured to generate an in-phase branch E1 of the first local oscillation signal and a quadrature branch E2 of the first local oscillation signal, and to generate an in-phase branch F1 of the second local oscillation signal and a quadrature branch F2 of the second local oscillation signal. Specifically, the frequency synthesizer and divider 204 comprises a frequency synthesizer 218, a first divider 220 and a second divider 222. The frequency synthesizer 218 is communicatively coupled to both the first divider 220 and the second divider 222, and configured to generate and send a double-frequency signal J to both the first divider 220 and the second divider 222. The double-frequency signal J may be a local oscillation signal at frequency F_{J}=1571.328*2=3142.656 MHz. The first divider 120 is further communicatively coupled to the first mixer 106 and configured to send an in-phase branch E1 of the first middle frequency signal E and a quadrature branch E2 of the first middle frequency signal E to the first mixer 206 by dividing the double-frequency signal J by two. Therefore the in-phase branch E1 and the quadrature branch E2 of the first local oscillation signal have a frequency of F_{E1}=F_{E2}=F_{J}/2=1571.328 MHz. The local oscillation frequency of the first local oscillation signal can be 16.368*96=1571.328 MHz with 16.368 MHz crystal oscillation, therefore the circuit can have an integer number of Phase Locked Loops (PLL). The second divider 222 is further communicatively coupled to the second mixer 208 and configured to send the second middle frequency signal F to the second mixer by dividing the double-frequency signal J by a divisor.

The divisor of the second divider DIV2 is configurable according to types of the first satellite navigation signal and the second satellite navigation signal. For example, if the first satellite navigation signal is Global Positioning System (GPS) L1 signal which has a frequency of 1575.42 MHz, and the second satellite navigation signal is BeiDou Navigation Satellite System B1 signal which has a frequency of 1561.1 MHz, the divisor of the second divider DIV2 222 can be chosen as 220, if the divisor of the first divider 220 is fixed to 2. As a result, the in-phase branch F1 and the quadrature branch F2 of the second local oscillation signal F have a frequency of F_{F1}=F_{F2}=F_{J}/220=14.2848 MHz. Note the frequency mix of the first local oscillation signal and the BDS signal (1561.098 MHz) is 10.23 MHz, and the output of the second mixed middle frequency signal ranges from 4-6 MHz which is easy to demodulate, the frequency of the second local oscillation signal F is chosen as 14.2848 MHz. Alternatively, if the first satellite navigation signal is Global Positioning System (GPS) L1 signal, and the second satellite navigation signal is Global Navigation Satellite System (GLONASS) L1 signal, the divisor of the second divider DIV2 222 can be chosen as 128, if the divisor of the first divider 220 is fixed to 2. As a result, the in-phase branch F1 and the quadrature branch F2 of the second local oscillation signal F have a frequency of F_{F1}=F_{F2}=F_{J}/128=24.552 MHz.

### Embodiment 2

In the above Embodiment 1, the circuit outputs combination of GPS L1 signal and BDS B1 signal, or the circuit outputs combination of GPS L1 signal and GLONASS L1 signal. Alternatively, in the following embodiment 2, the circuit may output combination of GPS L5 signal and BDS B2 signal, or the circuit outputs the combination of GPS L5 signal and GLONASS L2 signal. For example, the double-frequency signal J may be a local oscillation signal at frequency F_{J}=1178.496*2=2356.992 MHz. In this case, if the first satellite navigation signal is Global Positioning System (GPS) L5 signal which has a frequency of 1176.45 MHz, and the second satellite navigation signal is BeiDou Navigation Satellite System B2 signal which has a frequency of 1246 MHz, the divisor of the second divider DIV2 222 can be chosen as 32, if the divisor of the first divider 220 is fixed to 2. As a result, the in-phase branch E1 and the quadrature branch E2 of the first local oscillation signal E have a frequency of F_{E1}=F_{E2}=F_{J}/2=1178.496 MHz, and the in-phase branch F1 and the quadrature branch F2 of the second local oscillation signal F have a frequency of F_{J}/32=73.656 MHz.

Alternatively, the double-frequency signal J may be an local oscillation signal at frequency F_{J}=1178.496*2=2356.992 MHz. In this case, if the first satellite navigation signal is Global Positioning System (GPS) L5 signal which has a frequency of 1176.45 MHz, and the second satellite navigation signal is Global Navigation Satellite System (GLONASS) L2 signal which has a frequency of 1207.14 MHz, the divisor of the second divider DIV2 222 can be chosen as 64, if the divisor of the first divider 220 is fixed to 2. As a result, the in-phase branch E1 and the quadrature branch E2 of the first local oscillation signal E have a frequency of F_{E1}=F_{E2}=F_{J}/2=1178.496 MHz, and the in-phase branch F1 and the quadrature branch F2 of the second local oscillation signal F have a frequency of F_{J}/64=36.828 MHz. Note although GPS, Beidou and GLONASS global navigation satellite system signals are used as examples, those skilled in the art can understand that other navigation satellite system signals including global navigation satellite system and regional navigation satellite system, such as Galileo in Europe, NAVigation with Indian Constellation (NAVIC), or Quasi-Zenith Satellite System (QZSS) in Japan, can also be used in the embodiments.

Further, the first mixer 206 is further configured to generate an in-phase branch B1 of the first middle frequency signal B by mixing the RF signal A with the in-phase branch E1 of the first local oscillation signal E and a quadrature branch B2 of the first middle frequency signal B by mixing the RF signal A with the quadrature branch E2 of the first local oscillation signal E, therefore down-converting the RF signal A to the in-phase branch B1 and quadrature branch B2 of the first middle frequency signal B. In-phase branch B1 and quadrature branch B2 of the first middle frequency signal B may include GPS L1 signal and BDS B1 signal, or GPS L1 signal and GLONASS L1 signal, or GPS L5 signal and BDS B2 signal, or GPS L5 signal and GLONASS L2 signal.

The second mixer 208 is further configured to generate an in-phase branch G1 of the second middle frequency signal G by mixing the in-phase branch B1 of the first middle frequency signal B with the in-phase branch F1 of the second local oscillation signal F, and a quadrature branch G2 of the second middle frequency signal G by mixing the quadrature branch B2 of the first middle frequency signal B with the quadrature branch F2 of the second local oscillation signal F. Similar to the In-phase branch B1 and quadrature branch B2, In-phase branch G1 and quadrature branch G2 of the second middle frequency signal G may include GPS L1 signal and BDS B1 signal, or GPS L1 signal and GLONASS L1 signal, or GPS L5 signal and BDS B2 signal, or GPS L5 signal and GLONASS L2 signal.

The first complex band path filter 210 is further configured to generate an in-phase branch C1 and a quadrature branch C2 of the first satellite navigation signal C by filtering the in-phase branch B1 of the first middle frequency signal B and the quadrature branch B2 of the first middle frequency signal B to suppress signal in unwanted frequency band. For example, the first complex band path filter 210 is used to derive the GPS L1 or GPS L5 signal and suppress the other navigation signals, such as BDS B1, BDS B2, GLONASS L1, or GLONASS L2 navigation signal. Therefore, in-phase branch C1 and a quadrature branch C2 of the first satellite navigation signal C only includes GPS L1 or GPS L5, depending on the configuration of divisors of the first divider 220 and the second divider 222 in the FS-DIV 204.

The second complex band path filter 212 is further configured to generate an in-phase branch H1 and a quadrature branch H2 of the second satellite navigation signal H by filtering the in-phase branch of the second middle frequency signal and the quadrature branch of the second middle frequency signal to suppress signal in unwanted frequency band. For example, the second complex band path filter 212 is used to derive the BDS B1, BDS B2, GLONASS L1, or GLONASS L2 signal and suppress the other navigation signals, such as GPS L1 or GPS L5 navigation signal. Therefore, in-phase branch H1 and a quadrature branch H2 of the second satellite navigation signal only includes BDS B1, BDS B2, GLONASS L1, or GLONASS L2 signal, depending on the configuration of divisors of the first divider 220 and the second divider 222 in the FS-DIV 204.

For example, in the case that the RF front circuit 200 is used to treat GPS L1 and BDS B1 signals, the frequency of the in-phase branch C1 and a quadrature branch C2 of the first satellite navigation signal C is 4.092 MHz, and the frequency of in-phase branch H1 and a quadrature branch H2 of the second satellite navigation signal H is 4.0548 MHz. Alternatively, in the case that the RF front circuit 200 is used to treat GPS L1 and GLONASS L1 signals, the frequency of the in-phase branch C1 and a quadrature branch C2 of the first satellite navigation signal C is 4.092 MHz, and the frequency of in-phase branch H1 and a quadrature branch H2 of the second satellite navigation signal H is 6.12 MHz. Alternatively, in the case that the RF front circuit 200 is used to treat GPS L5 and BDS B2 signals, the frequency of the in-phase branch C1 and a quadrature branch C2 of the first satellite navigation signal C is 2.046 MHz, and the frequency of in-phase branch H1 and a quadrature branch H2 of the second satellite navigation signal H is 6.152 MHz. Alternatively, in the case that the RF front circuit 200 is used to treat GPS L5 and GLONASS L2 signals, the frequency of the in-phase branch C1 and a quadrature branch C2 of the first satellite navigation signal C is 2.046 MHz, and the frequency of in-phase branch H1 and a quadrature branch H2 of the second satellite navigation signal H is 8.184 MHz. Note although GPS, Beidou and GLONASS global navigation satellite system signals are used as examples, those skilled in the art can understand that other navigation satellite system signals can be used in the embodiments.

The following table 1 and table 2 show the frequency of the treated signals for RF front end circuit shown in FIG. 2 that is used to treat different combinations of satellite navigation signals.

TABLE 1

| Combination of treated | GPS L1 + | GPS L1 + | |
|---|---|---|---|
| signals | BDS B1 | GLONASS L1 | Unit |
| GPS L1 satellite signal | 1575.42 | 1575.42 | MHz |
| frequency | | | |
| BDS B1 or GLONASS L1 | 1561.098 | 1602 | MHz |
| satellite signal frequency | | | |
| First oscillation signal E1 | 1571.328 | 1571.328 | MHz |
| and E2 frequency | | | |
| Second oscillation signal F1 | 14.2848 | 24.552 | MHz |
| and F2 frequency | | | |
| the filtered first middle | 4.092 | 4.092 | MHz |
| frequency signal C1 | | | |
| and C2 frequency | | | |
| the filtered second middle | 4.0548 | 6.12 | MHz |
| frequency signal H1 and H2 | | | |

TABLE 2

| Combination of treated | GPS L5 + | GPS L5 + | |
|---|---|---|---|
| signals | BDS B2 | GLONASS L2 | [symbol] |
| GPS L5 satellite signal | 1176.45 | 1176.45 | MHz |
| frequency | | | |
| BDS B2 or GLONASS L2 | 1246 | 1207.14 | MHz |
| satellite signal frequency | | | |
| First oscillation signal E1 | 1178.496 | 1178.496 | MHz |
| and E2 frequency | | | |
| First oscillation signal E1 | 73.656 | 36.828 | MHz |
| and E2 frequency | | | |
| the filtered first middle | 2.046 | 2.046 | MHz |
| frequency signal C1 | | | |
| and C2 frequency | | | |
| the filtered second middle | 6.152 | 8.184 | MHz |
| frequency signal H1 and H2 | | | |

Further, the first analog to digital converter (ADC1) 214 is communicatively coupled to the first complex band path filter 210 and configured to generate a first digital satellite navigation signal D by converting the in-phase branch C1 of the first satellite navigation signal C digitally. For example, the first ADC 214 only converts the in-phase branch C1, as the baseband demodulation only needs one branch. The second analog to digital converter (ADC2) 216 is communicatively coupled to the second complex band path filter 112 and configured to generate a second digital satellite navigation signal I by converting the second satellite navigation signal H digitally. For example, the ADC 216 only converts in-phase signal H1, as the baseband demodulation only needs one branch.

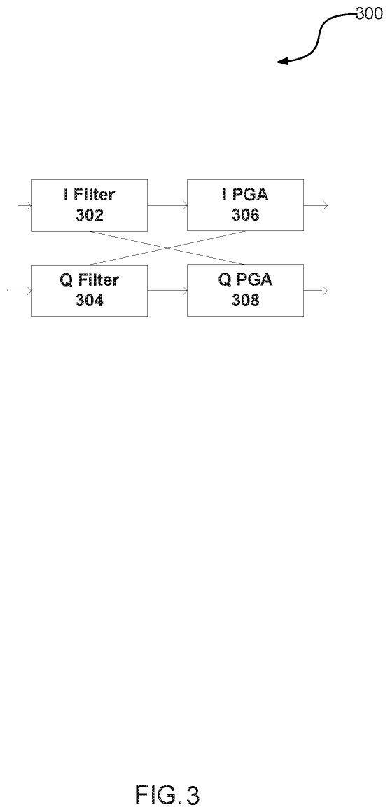

FIG. 3 is a circuit diagram of a complex band path filter 300 within the RF front end in a receiver according to an embodiment of the invention.

The first complex band path filter and the second complex band path filter each further comprises an in-phase branch filter 302 configured to filter an in-phase branch signal; a quadrature branch filter 304 configured to filter a quadrature branch signal; an in-phase branch programmable gain amplifier (I PGA) 306 communicatively connected to both the in-phase branch filter 302 and the quadrature branch filter 304 and configured to generate an in-phase branch of an amplified signal based on the in-phase branch signal and the quadrature branch signal; and a quadrature branch programmable gain amplifier (Q PGA) 308 communicatively connected to both the in-phase branch filter 302 and the quadrature branch filter 304 and configured to generate a quadrature branch of the amplified signal based on the in-phase branch signal and the quadrature branch signal.

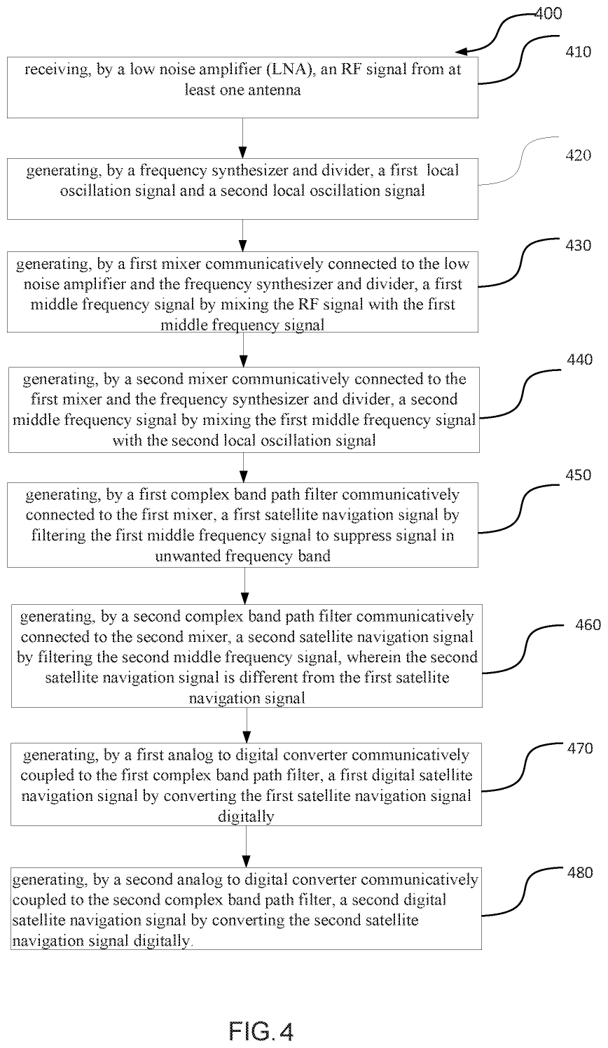

FIG. 4 is a flow chart of a method 400 in a RF front end in a receiver according to an embodiment of the invention. The method 400 comprises receiving, in block 410, by a low noise amplifier (LNA), an RF signal from an antenna; generating, in block 420 by a frequency synthesizer and divider, a first local oscillation signal and a second local oscillation signal; generating, in block 430 by a first mixer communicatively connected to the low noise amplifier and the frequency synthesizer and divider, a first middle frequency signal by mixing the RF signal with the first local oscillation signal; generating, in block 440 by a second mixer communicatively connected to the first mixer and the frequency synthesizer and divider, a second middle frequency signal by mixing the first middle frequency signal with the second local oscillation signal; generating, in block 450 by a first complex band path filter communicatively connected to the first mixer, a first satellite navigation signal by filtering the first middle frequency signal to suppress signal in unwanted frequency band; generating, in block 460 by a second complex band path filter communicatively connected to the second mixer, a second satellite navigation signal by filtering the second middle frequency signal to suppress signal in unwanted frequency band, wherein the second satellite navigation signal is different from the first satellite navigation signal; generating, in block 470 by a first analog to digital converter communicatively coupled to the first complex band path filter, a first digital satellite navigation signal by converting the first satellite navigation signal digitally; and generating in block 480, by a second analog to digital converter communicatively coupled to the second complex band path filter, a second digital satellite navigation signal by converting the second satellite navigation signal digitally.

Alternatively, generating in block 420, by the frequency synthesizer and divider, a first local oscillation signal and a second local oscillation signal is further implemented by generating an in-phase branch of the first local oscillation signal and a quadrature branch of the first local oscillation signal, and generating an in-phase branch of the second local oscillation signal and a quadrature branch of the second local oscillation signal; and generating in block 430, by the first mixer communicatively connected to the low noise amplifier and the frequency synthesizer and divider, a first middle frequency signal by mixing the RF signal with the first middle frequency signal is further implemented by generating an in-phase branch of the first middle frequency by mixing the RF signal with the in-phase branch of the first local oscillation signal and a quadrature branch of the first middle frequency signal by mixing the RF signal with the quadrature branch of the first local oscillation signal; generating in block 440, by the second mixer communicatively connected to the first mixer and the frequency synthesizer and divider, a second middle frequency signal by mixing the first middle frequency signal with the second local oscillation signal is further implemented by generating an in-phase branch of the second middle frequency signal by mixing the in-phase branch of the first middle frequency signal with the in-phase branch of the second local oscillation signal, and a quadrature branch of the second middle frequency signal by mixing the quadrature branch of the first middle frequency signal with the quadrature branch of the second local oscillation signal; generating in block 450, by the first complex band path filter communicatively connected to the first mixer, a first satellite navigation signal by filtering the first middle frequency signal is further implemented by generating an in-phase branch and a quadrature branch of the first satellite navigation signal by filtering the in-phase branch of the first middle frequency signal and the quadrature branch of the first middle frequency signal to suppress signal in unwanted frequency band; and generating in block 460, by the second complex band path filter communicatively connected to the second mixer, a second satellite navigation signal by filtering the second middle frequency signal is further implemented by generating an in-phase branch and a quadrature branch of the second satellite navigation signal by filtering the in-phase branch of the second middle frequency signal and the quadrature branch of the second middle frequency signal to suppress signal in unwanted frequency band.

Alternatively, wherein generating in block 450, by a first complex band path filter communicatively connected to the first mixer, a first satellite navigation signal by filtering the first middle frequency signal and generating in block 460, by a second complex band path filter communicatively connected to the second mixer, a second satellite navigation signal by filtering the second middle frequency signal each is further implemented by filtering, by an in-phase branch filter, an in-phase branch signal; filtering, by a quadrature branch filter, a quadrature branch signal; generating, by an in-phase branch programmable gain amplifier communicatively connected to both the in-phase branch filter and the quadrature branch filter, an in-phase branch of an amplified signal based on the in-phase branch signal and the quadrature branch signal; and generating, by a quadrature branch programmable gain amplifier communicatively connected to both the in-phase branch filter and the quadrature branch filter, a quadrature branch of the amplified signal based on the in-phase branch signal and the quadrature branch signal.

Alternatively, wherein the first satellite navigation signal and the second satellite navigation signal are from different navigation satellite systems.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made without deviating from the spirit and scope of the present invention. Moreover, features of one embodiment may be incorporated into other embodiments, even where those features are not described together in a single embodiment within the present document. Accordingly, the invention is described by the appended claims

What is claimed is:

1. An RF front end circuit in a receiver, comprising:
a low noise amplifier configured to receive an RF signal from an antenna;
a frequency synthesizer and divider, configured to generate a first local oscillation signal and a second local oscillation signal;
a first mixer communicatively connected to the low noise amplifier and the frequency synthesizer and divider, and configured to generate a first middle frequency signal by mixing the RF signal with the first local oscillation signal;
a second mixer communicatively connected to the first mixer and the frequency synthesizer and divider, and configured to generate a second middle frequency signal by mixing the first middle frequency signal with the second local oscillation signal;
a first complex band path filter communicatively connected to the first mixer and configured to generate a first satellite navigation signal by filtering the first middle frequency signal to suppress signal in unwanted frequency band;
a second complex band path filter communicatively connected to the second mixer and configured to generate a second satellite navigation signal by filtering the second middle frequency signal to suppress signal in unwanted frequency band, wherein the second satellite navigation signal is different from the first satellite navigation signal;
a first analog to digital converter (ADC) communicatively coupled to the first complex band path filter and configured to generate a first digital satellite navigation signal by converting the first satellite navigation signal digitally; and
a second analog to digital converter (ADC) communicatively coupled to the second complex band path filter and configured to generate a second digital satellite navigation signal by converting the second satellite navigation signal digitally.

2. The RF front end circuit of claim 1, wherein
the frequency synthesizer and divider is further configured to generate an in-phase branch of the first local oscillation signal and a quadrature branch of the first local oscillation signal, and to generate an in-phase branch of the second local oscillation signal and a quadrature branch of the second local oscillation signal;
the first mixer is further configured to generate an in-phase branch of the first middle frequency signal by mixing the RF signal with the in-phase branch of the first local oscillation signal and a quadrature branch of the first middle frequency signal by mixing the RF signal with the quadrature branch of the first local oscillation signal;
the second mixer is further configured to generate an in-phase branch of the second middle frequency signal by mixing the in-phase branch of the first middle frequency signal with the in-phase branch of the second local oscillation signal, and a quadrature branch of the second middle frequency signal by mixing the quadrature branch of the first middle frequency signal with the quadrature branch of the second local oscillation signal;
the first complex band path filter is further configured to generate an in-phase branch and a quadrature branch of the first satellite navigation signal by filtering the in-phase branch of the first middle frequency signal and the quadrature branch of the first middle frequency signal to suppress signal in unwanted frequency band; and
the second complex band path filter is further configured to generate an in-phase branch and a quadrature branch of the second satellite navigation signal by filtering the in-phase branch of the second middle frequency signal and the quadrature branch of the second middle frequency signal to suppress signal in unwanted frequency band.

3. The RF front end circuit of claim 1, wherein each of the first complex band path filter and the second complex band path filter further comprises:
an in-phase branch filter configured to filter an in-phase branch signal;
a quadrature branch filter configured to filter a quadrature branch signal;
an in-phase branch programmable gain amplifier (I-PGA) communicatively connected to both the in-phase branch filter and the quadrature branch filter and configured to generate an in-phase branch of an amplified signal based on the in-phase branch signal and the quadrature branch signal; and
a quadrature branch programmable gain amplifier (Q-PGA) communicatively connected to both the in-phase branch filter and the quadrature branch filter and configured to generate a quadrature branch of the amplified signal based on the in-phase branch signal and the quadrature branch signal.

4. The RF front end circuit of claim 1, wherein the frequency synthesizer and divider further comprises a frequency synthesizer, a first divider and a second divider, wherein the frequency synthesizer is communicatively coupled to both the first divider and the second divider, and configured to generate and send a double-frequency signal to the first divider and the second divider;
wherein the first divider is further communicatively coupled to the first mixer and configured to send the first middle frequency signal to the first mixer by dividing the double-frequency signal by two;
wherein the second divider is further communicatively coupled to the second mixer and configured to send the second middle frequency signal to the second mixer by dividing the double-frequency signal by a divisor.

5. The RF front end circuit of claim 4, wherein the divisor of the second divider is configurable according to types of the first satellite navigation signal and the second satellite navigation signal.

6. The RF front end circuit of claim 1, wherein the first satellite navigation signal and the second satellite navigation signal are from different systems.

7. A method in a receiver, comprising:
receiving, by a low noise amplifier (LNA), an RF signal from an antenna;
generating, by a frequency synthesizer and divider, a first local oscillation signal and a second local oscillation signal;
generating, by a first mixer communicatively connected to the low noise amplifier and the frequency synthesizer and divider, a first middle frequency signal by mixing the RF signal with the first local oscillation signal;
generating, by a second mixer communicatively connected to the first mixer and the frequency synthesizer and divider, a second middle frequency signal by mixing the first middle frequency signal with the second local oscillation signal;
generating, by a first complex band path filter communicatively connected to the first mixer, a first satellite navigation signal by filtering the first middle frequency signal to suppress signal in unwanted frequency band;
generating, by a second complex band path filter communicatively connected to the second mixer, a second satellite navigation signal by filtering the second middle frequency signal to suppress signal in unwanted frequency band, wherein the second satellite navigation signal is different from the first satellite navigation signal;
generating, by a first analog to digital converter communicatively coupled to the first complex band path filter, a first digital satellite navigation signal by converting the first satellite navigation signal digitally; and
generating, by a second analog to digital converter communicatively coupled to the second complex band path filter, a second digital satellite navigation signal by converting the second satellite navigation signal digitally.

8. The method of claim 7, wherein
generating, by the frequency synthesizer and divider, a first local oscillation signal and a second local oscillation signal is further implemented by generating an in-phase branch of the first local oscillation signal and a quadrature branch of the first local oscillation signal, and generating an in-phase branch of the second local oscillation signal and a quadrature branch of the second local oscillation signal;
generating, by the first mixer communicatively connected to the low noise amplifier and the frequency synthesizer and divider, a first middle frequency signal by mixing the RF signal with the first middle frequency signal is further implemented by generating an in-phase branch of the first middle frequency by mixing the RF signal with the in-phase branch of the first local oscillation signal and a quadrature branch of the first middle frequency signal by mixing the RF signal with the quadrature branch of the first local oscillation signal;
generating, by the second mixer communicatively connected to the first mixer and the frequency synthesizer and divider, a second middle frequency signal by mixing the first middle frequency signal with the second local oscillation signal is further implemented by generating an in-phase branch of the second middle frequency by mixing the in-phase branch of the first middle frequency signal with the in-phase branch of the second local oscillation signal, and a quadrature branch of the second middle frequency signal by mixing the quadrature branch of the first middle frequency signal with the quadrature branch of the second local oscillation signal;
generating, by the first complex band path filter communicatively connected to the first mixer, a first satellite navigation signal by filtering the first middle frequency signal is further implemented by generating an in-phase branch and a quadrature branch of the first satellite navigation signal by filtering the in-phase branch of the first middle frequency signal and the quadrature branch of the first middle frequency signal to suppress signal in unwanted frequency band; and
generating, by the second complex band path filter communicatively connected to the second mixer, a second satellite navigation signal by filtering the second middle frequency signal is further implemented by generating an in-phase branch and a quadrature branch of the second satellite navigation signal by filtering the in-phase branch of the second middle frequency signal and the quadrature branch of the second middle frequency signal to suppress signal in unwanted frequency band.

9. The method of claim 7, wherein generating, by a first complex band path filter communicatively connected to the first mixer, a first satellite navigation signal by filtering the first middle frequency signal and generating, by a second complex band path filter communicatively connected to the second mixer, a second satellite navigation signal by filtering the second middle frequency signal each is further implemented by
filtering, by an in-phase branch filter, an in-phase branch signal;
filtering, by a quadrature branch, a quadrature branch signal;
generating, by an in-phase branch programmable gain amplifier communicatively connected to both the in-phase branch filter and the quadrature branch filter, an in-phase branch of an amplified signal based on the in-phase branch signal and the quadrature branch signal; and
generating, by a quadrature branch programmable gain amplifier communicatively connected to both the in-phase branch filter and the quadrature branch filter, a quadrature branch of the amplified signal based on the in-phase branch signal and the quadrature branch signal.

10. The method of claim 7, wherein the first satellite navigation signal and the second satellite navigation signal are from different systems.
